(19) United States
(12) Patent Application Publication
(10) Pub. No.: US 2014/0026968 A1
(43) Pub. Date: Jan. 30, 2014

(54) SYSTEMS AND METHODS FOR SPLITTING DROPLETS

(71) Applicants: Adam R. Abate, San Francisco, CA (US); David A. Weitz, Bolton, MA (US)

(72) Inventors: Adam R. Abate, San Francisco, CA (US); David A. Weitz, Bolton, MA (US)

(21) Appl. No.: 13/979,984

(22) PCT Filed: Feb. 6, 2012
(86) PCT No.: PCT/US12/23961

§ 371 Date: Oct. 2, 2013

Related U.S. Application Data
(60) Provisional application No. 61/440,198, filed on Feb. 7, 2011.

(51) Int. Cl. B01L 3/00

(52) U.S. Cl. CPC B01L 3/5027
USPC 137/1; 137/561 A

(57) ABSTRACT

The present invention generally relates to fluidics and microfluidics and, in particular, to creating droplets in a fluidic system. In some aspects, the present invention is generally directed to systems and methods for splitting a parent droplet into two or more droplets, e.g., by urging the parent droplet towards an obstacle to split the parent droplet. In some cases, the parent droplet is split into at least first and second droplets which each are directed to separate channels. In some cases, the channels may be constructed and arranged such that the droplet velocities of the first and second droplets are substantially the same as the velocity of the parent droplet. In some cases, such droplets may be repeatedly split, e.g., a parent droplet is divided into 2 daughter droplets, then each droplet split again, etc., for example, such that one parent droplet may eventually be split into 2², 2³, 2⁴, 2⁵, 2⁶, etc. daughter droplets. In some cases, the daughter droplets may be substantially monodisperse.

### RELATED APPLICATIONS

This application claims the benefit of U.S. Provisional Patent Application Ser. No. 61/440,198, filed Feb. 7, 2011, entitled “Systems and Methods for Splitting Droplets,” by Abate, et al., incorporated herein by reference.

### GOVERNMENT FUNDING

Research leading to various aspects of the present invention were sponsored, at least in part, by NSF, Grant No. DMR-0602684, and MRSEC, Grant No. DMR-0820484. The U.S. Government has certain rights in the invention.

### FIELD OF INVENTION

The present invention generally relates to fluidics and microfluidics and, in particular, to creating droplets in a fluidic system.

### BACKGROUND

The manipulation of fluids to form fluid streams of desired configurations, discontinuous fluid streams, droplets, particles, dispersions, etc., for purposes of fluid delivery, product manufacture, analysis, and the like, is a relatively well-studied art. For example, highly monodisperse droplets, less than 100 micrometers in diameter, have been produced using a technique commonly referred to as flow focusing. In this technique, a fluid is forced out of a capillary tube into a bath of liquid, where the tube is positioned above a small orifice, and the contraction flow of the external liquid through this orifice focuses the gas into a thin jet which subsequently breaks into equal-sized droplets via capillary instability. A similar arrangement can be used to produce liquid droplets in air.

Fluid droplets can also be manipulated, for example, by splitting fluid droplets into two droplets. Examples include the splitting of droplets by directing the droplets towards an obstacle, such as is disclosed in U.S. patent application Ser. No. 11/024,228, filed Dec. 28, 2004, entitled “Method and Apparatus for Fluid Dispersion,” by Stone, et al., now U.S. Pat. No. 7,708,949, issued May 4, 2010, or U.S. patent application Ser. No. 11/360,845, filed Feb. 23, 2006, entitled “Electronic Control of Fluidic Species,” by Link, et al., published as U.S. Patent Application Publication No. 2007/0003442 on Jan. 4, 2007 (each incorporated herein by reference in its entirety). However, such techniques have not been as useful for producing large numbers of droplets, e.g., from a single starting (or “parent”) droplet. In such systems, a larger number of channels is typically required, resulting in a correspondingly larger amount of fluid that is required to fill such channels; the larger amount of required fluid limits such systems from being repeated in a single device (e.g., such that a parent droplet can be split 3 times, 4 times, 5 times, etc.). In addition, fluid flow rates through such systems are often not constant due to the increasing number of downstream channels, and thus, fluid flows in such systems are not easy to control. Accordingly, improvements in devices and methods for splitting droplets are needed.

### SUMMARY OF THE INVENTION

The present invention generally relates to fluidics and microfluidics and, in particular, to creating droplets in a fluidic system. The subject matter of the present invention involves, in some cases, interrelated products, alternative solutions to a particular problem, and/or a plurality of different uses of one or more systems and/or articles.

In one aspect, the present invention is generally directed to a method of splitting a parent droplet into two or more droplets. According to one set of embodiments, the method includes acts of providing a parent droplet flowing at an initial velocity in an inlet microfluidic channel, splitting the parent droplet into at least a first droplet and a second droplet, and urging the first droplet into a first microfluidic channel and the second droplet into a second microfluidic channel, where the first droplet flows at a first velocity within the first microfluidic channel and the second droplet flows at a second velocity within the second microfluidic channel. The first velocity and the second velocity can be the same or different. In some embodiments, the difference in velocities between the fastest and slowest of the initial, first, and second velocities is no more than about 40% of the initial velocity.

In another set of embodiments, the method is a method of splitting a parent droplet into two or more droplets. In some embodiments, the method includes acts of providing a parent droplet flowing in an inlet microfluidic channel at an initial Capillary number, splitting the parent droplet into at least a first droplet and a second droplet, and urging the first droplet into a first microfluidic channel and the second droplet into a second microfluidic channel, where the first droplet flows in the first microfluidic channel at a first Capillary number and the second droplet flows in the second microfluidic channel at a second Capillary number. The first Capillary number and the second Capillary number can be the same or different. In some cases, the difference in Capillary numbers between the largest and smallest of the initial, first, and second Capillary numbers is no more than about 20% of the initial Capillary number.

The method, in yet another set of embodiments, is a method of splitting a double emulsion droplet. According to certain embodiments, the method includes acts of providing a parent double emulsion droplet flowing in a microfluidic channel towards an obstacle, where the double emulsion droplet comprises an inner fluid surrounded by an outer fluid, and splitting the parent double emulsion droplet via impact with the obstacle into at least a first double emulsion droplet and a second double emulsion droplet.

In still another set of embodiments, the method is a method of producing relatively uniform droplets. In some embodiments, the method includes an act of dividing a parent droplet a plurality of times to produce at least 2⁴ daughter droplets. In certain instances, the daughter droplets have a coefficient of variation of volume of no more than about 20%.

The method, in accordance with yet another set of embodiments, is a method of producing relatively uniform droplets. In some cases, the method includes an act of dividing a parent droplet a plurality of times to produce at least 2⁴ daughter droplets. In certain instances, the daughter droplets have a distribution in volumes such that at least about 90% of the daughter droplets have a diameter that is no more than about 20% different than the average diameter of the daughter droplets.

In another aspect, the present invention is generally directed to a microfluidic device for splitting droplets. The device, in accordance with one set of embodiments, includes an inlet microfluidic channel ending at an intersection with at least two daughter microfluidic channels, where the inlet microfluidic channel has a cross-sectional area and the at least two daughter microfluidic channels each has a cross-sectional area. The difference in cross-sectional areas between the inlet microfluidic channel and the sum of the cross-sectional areas of the at least two daughter microfluidic channels may be no more than about 40% of the cross-sectional area of the inlet microfluidic channel, at least in some cases.

In some embodiments, the device includes an inlet microfluidic channel ending at an intersection with at least two daughter microfluidic channels, where the inlet microfluidic channel has a height and a width, and each of the daughter microfluidic channels has a height and a width, and where the heights of the inlet microfluidic channel and each of the daughter microfluidic channels are substantially equal, and the width of the inlet microfluidic channel is substantially equal to the sum of the widths of the daughter microfluidic channels.

In certain aspects, the present invention is generally directed to a device for creating microfluidic droplets. The device, in certain embodiments, comprises a droplet maker able to create a plurality of parent droplets contained within an inlet channel, and a network of channels that receives droplets from the inlet channel. The plurality of parent droplets has an average volume of at least about 0.01 mm³ per droplet, in some embodiments. In certain cases, the network of channels comprises at least 4 generations. In some embodiments, some or all of the generations comprise an inlet channel ending at an intersection with at least two daughter channels.

In another aspect, the present invention encompasses methods of making one or more of the embodiments described herein, for example, devices for splitting droplets in a microfluidic system. In still another aspect, the present invention encompasses methods of using one or more of the embodiments described herein, for example, devices for splitting droplets in a microfluidic system.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A illustrates a device in accordance with one embodiment of the invention;

FIG. 1B illustrates a comparative example;

FIG. 2 illustrates a device having a plurality of generations of splitting junctions, according to another embodiment of the invention;

FIGS. 3A-3B illustrate various devices with obstacles, in yet another embodiment of the invention;

FIGS. 4A-4B illustrate various devices for splitting droplets, according to various embodiments of the invention;

FIG. 5 illustrates double emulsion droplets being split, in accordance with another embodiment of the invention;

FIGS. 6A-6B are graphs of the lengths of single and double emulsion droplets, in accordance with certain embodiments of the invention; and

FIGS. 7A-7D illustrate relatively narrow size distributions of single and double emulsions, in accordance with various embodiments of the invention.

### DETAILED DESCRIPTION

The present invention generally relates to fluidics and microfluidics and, in particular, to creating droplets in a fluidic system. In some aspects, the present invention is generally directed to systems and methods for splitting a parent droplet into two or more droplets, e.g., by urging the parent droplet towards an obstacle to split the parent droplet. In some cases, the parent droplet is split into at least first and second droplets which each are directed to separate channels. In some cases, the channels may be constructed and arranged such that the droplet velocities of the first and second droplets are substantially the same as the velocity of the parent droplet. In some cases, such droplets may be repeatedly split, e.g., a parent droplet is split into 2 daughter droplets, then each droplet split again, etc., for example, such that one parent droplet may eventually be split into 2², 2³, 2⁴, 2⁵, 2⁶, etc. daughter droplets. In some cases, the daughter droplets may be substantially monodisperse.

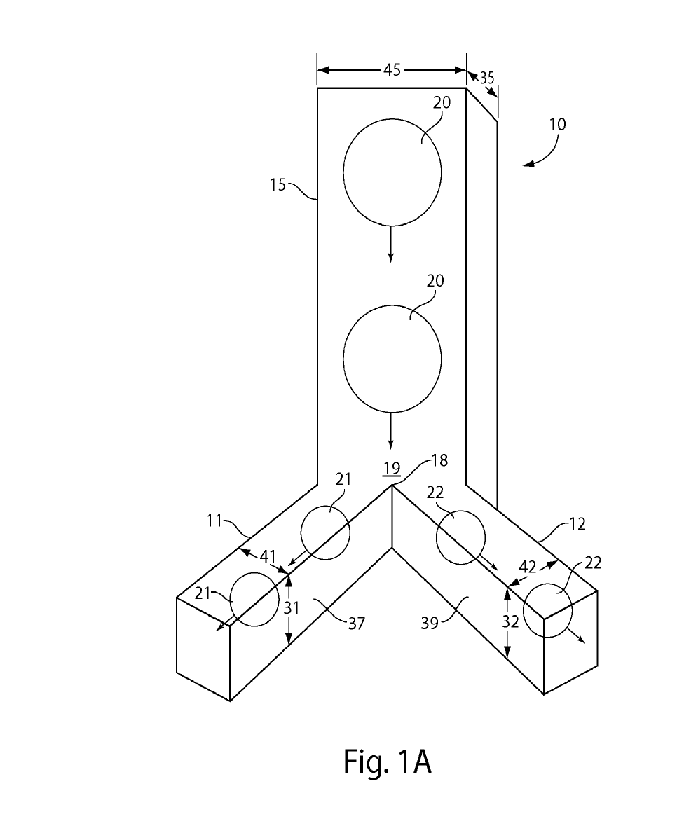

One aspect of the present invention is generally directed to systems and methods for splitting a parent droplet into two or more droplets. For instance, as shown in the example of FIG. 1A, in microfluidic system 10, inlet channel 15 splits into first channel 11 and second channel 12 at intersection 19. First channel 11 and second channel 12 may proceed at any suitable angle away from inlet channel 15. For example, first channel 11 and second channel 12 may be at a relatively sharp or relatively shallow angle, or they may even be at 180° from each other (e.g., forming a “T” junction with inlet channel 15). In addition, first channel 11 and second channel 12 may be at the same, or different angles, with respect to inlet channel 15, i.e., first channel 11 and second channel 12 may be symmetrically or nonsymmetrically arranged relative to inlet channel 15. Furthermore, as discussed below, in other embodiments, other numbers of channels may be present, e.g., for splitting a parent droplet into 3, 4, or more droplets.

Within inlet channel 15 is parent droplet 20. Parent droplet 20 may be a single droplet or a nested droplet (e.g., a double emulsion). Parent droplet 20 is urged by fluid flow within inlet channel 15 towards obstacle 18. In this figure, obstacle 18 is defined by the intersection of first channel 11 and second channel 12, although in other embodiments, the obstacle may be a separate structure, e.g., a peg. Upon impacting obstacle 18, parent droplet 20 may be split into first droplet 21 and second droplet 22. First droplet 21 then flows into first channel 11, and second droplet 22 then flows into second channel 12. In some cases, the division of parent droplet 20 into first droplet 21 and second droplet 22 may be controlled, e.g., by controlling the relative hydrodynamic fluid resistances of first channel 11 and second channel 12, e.g., in a manner akin to Ohm's Law, as discussed below. In some embodiments, the fluid resistances of first channel 11 and second channel 12 may be substantially equal, such that the volumes of first droplet 21 and second droplet 22 are also substantially equal, e.g., as is shown in FIG. 1A.

It should be noted that inlet channel 15, first channel 11, and second channel 12, as shown in FIG. 1A, are constructed and arranged such that the cross-sectional area of inlet channel 15 is substantially equal to the sum of the cross-sectional areas of first channel 11 and second channel 12. As the volumetric flow rate through inlet channel 15 must be equal to the sum of the volumetric flow rates through first channel 11 and second channel 12 (since all fluid flows into intersection 19 must be equal to all fluid flows out of intersection 19), by keeping the areas substantially equal, the linear flow rates within inlet channel 15, first channel 11, and second channel 12 can also be kept substantially equal. In FIG. 1A, the height 35 of inlet channel 15 is substantially the same as the heights 31, 32 of first channel 11 and second channel 12, respectively; however, the widths 41, 42 of first channel 11 and second channel 12 are smaller than the width 45 of inlet channel 15 such that the cross-sectional area of the inlet channel is substantially equal to the sum of the cross-sectional areas of the first and second channels.

However, it should be noted that there are other ways to control the splitting of a parent droplet into a first droplet and a second droplet. For example, the channels may be constructed and arranged such that the Capillary numbers of fluid flow within the inlet channel, and within the first and second channels, are all substantially equal, or some of the channels may also have different heights. Examples of these are discussed in more detail below.

In contrast, in FIG. 1B, a comparative example is illustrated in which the cross-sectional area of the inlet channel is substantially equal to each of the cross-sectional areas of the first and second channels, where the first and second channels have substantially the same dimensions (i.e., instead of being equal to the sum of the cross-sectional areas of the first channel and the second channel, as in FIG. 1A). Thus, in FIG. 1B, the height of inlet channel 15 is substantially equal to the heights 31, 32 of first channel 11 and second channel 12, and the width of inlet channel 15 is substantially equal to each of the widths 41, 42 of first channel 11 and second channel 12, respectively. As the volumetric flow rate through inlet channel 15 must be equal to the sum of the volumetric flow rates through first channel 11 and second channel 12 (since all fluid flows into intersection 19 must be equal to all fluid flows out of intersection 19), as discussed above, the linear flow rates within first channel 11 and second channel 12 must each be half of the flow rate within inlet channel 15. In other words, because the cross-sectional area of fluid flow away from intersection 19 is twice the cross-sectional area of fluid flow into intersection 19, and the volumetric fluid flow rate through intersection 19 must be constant, it therefore follows that the linear fluid flow rates exiting intersection 19 must be half of those entering intersection 19. While such systems have been discussed in prior references, no one has suggested altering the sizes of the channels exiting such intersections as a way of simultaneously controlling both the volumetric flow rate and the linear flow rate through such systems, including within systems where multiple branches are used.

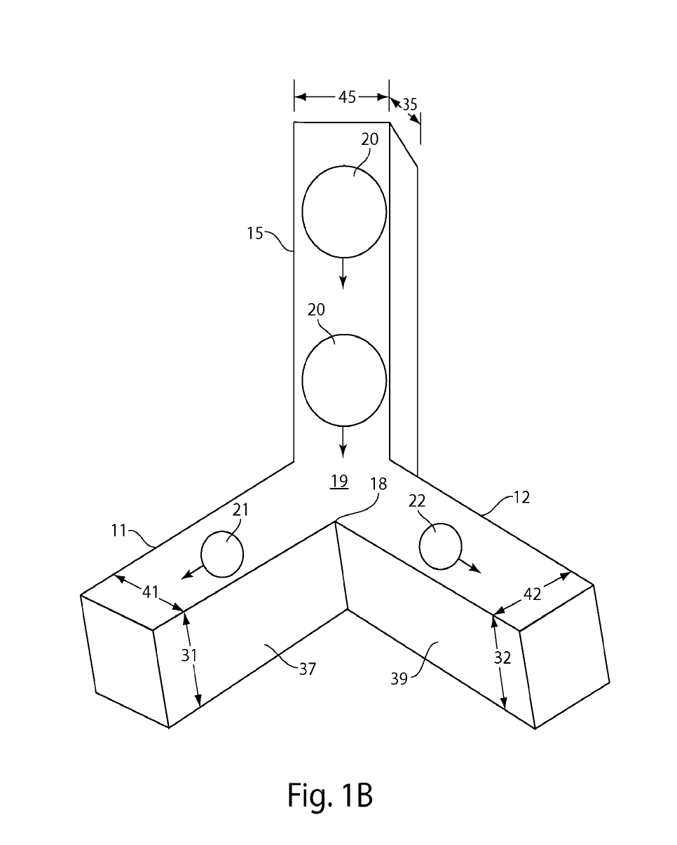

In certain embodiments, a daughter channel may itself serve as an inlet channel of a downstream intersection, as is shown in FIG. 2. In this way, a single inlet channel may give rise to daughter channels, granddaughter channels, great-granddaughter channels, etc. In FIG. 2, inlet channel 50 is split into two daughter channels 51, 52. As previously discussed, each of daughter channels 51, 52 may proceed in any suitable angle away from inlet channel 50. In addition, the sum of the cross-sectional areas of the daughter channels may be substantially equal to the cross-sectional area of the inlet channel, at least in some embodiments.

Each of daughter channels 51, 52, in turn, may be treated as an inlet channel, thereby giving rise to granddaughter channels 61, 62, 63, 64. As above, the sum of the cross-sectional areas of each pair of granddaughter channels 61, 62 and 63, 64 may be substantially equal to the cross-sectional areas of their respective inlet daughter channels 51, 52. Accordingly, the sum of the cross-sectional areas of all of granddaughter channels 61, 62, 63, 64 may also be substantially equal to the sum of the cross-sectional areas of the daughter channels, which in turn is substantially equal to the cross-sectional area of the inlet channel, as noted above.

This pattern may be repeated any suitable number of times, e.g., as is shown in FIG. 2 with great-granddaughter channels 71, 72, 73, 74, 75, 76, 77, 78. Thus, for instance, this splitting may be continued 2, 3, 4, 5, 6, 7, 8, 9, or 10 or more times, depending on the application. Accordingly, for example, if at each intersection an inlet channel is split into two daughter channels, then there may be 2, 2², 2³, 2⁴, 2⁵, 2⁶, 2⁷, 2⁸, 2⁹, or 2¹⁰ or more channels split from the initial inlet channel. As implied by the nomenclature, each “splitting” of an inlet channel into two or more daughter channels may be termed a generation; thus, in a network of channels extending from an initial channel, there may be any number of “generations” present, e.g., at least 2, 3, 4, 5, 6, 7, 8, 9, or 10 or more generations may be present in a device. Accordingly, in a device such as that shown in FIG. 2, a parent droplet 55 entering channel 50 may be split at each intersection defining a generation into 2 daughter droplets, 4 granddaughter droplets, 8 great-granddaughter droplets, etc., i.e., such that the original droplet is split into 2, 2², 2³, 2⁴, 2⁵, 2⁶, 2⁷, 2⁸, 2⁹, or 2¹⁰, etc. droplets, depending on the number of generations present within the device. In addition, it should be understood that the splitting of an inlet channel into two daughter channels is by way of example only; in other embodiments, a generation may be split into different numbers of channels (e.g., 3 channels, 4 channels, 5 channels, etc.) and each generation and/or each intersection within a device may independently have the same or different numbers of daughter channels present.

Accordingly, one aspect of the present invention is generally directed to systems and methods of splitting a parent droplet into two or more droplets using branching channels, where linear flow rates though the channels and/or fluidic Capillary numbers within the channels are controlled. A “Capillary number” represents the relative effect of viscous forces versus surface tension of fluid flowing through a channel. It can be defined as:

$$Ca {=}^{def} \frac{μ V}{γ} ,$$

where μ (mu) is the dynamic viscosity of the fluid, V is the velocity (or linear flow rate) of the fluid, and γ (gamma) is the surface or interfacial tension of the fluid with the surface of the channel.

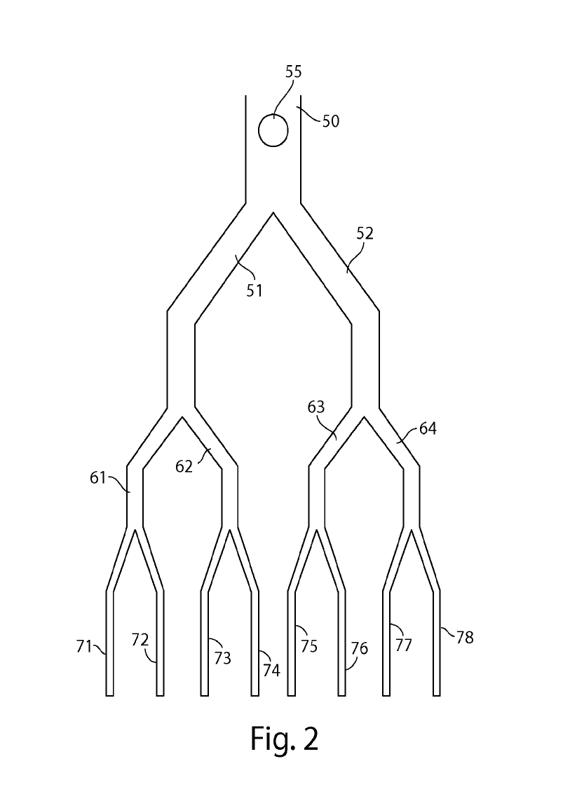

In one set of embodiments, an inlet channel enters an intersection and is split at the intersection into two, three, four, or more channels (“daughter channels”). An illustrative non-limiting example of such an embodiment with three daughter channels is illustrated in FIG. 3B. “Inlet” (as in “inlet channel”) in this case is defined relative to the intersection, i.e., fluid flows from the inlet channel towards the intersection. Fluid then flows out of the intersection through the daughter channels. In some instances, as discussed herein, this may be repeated, e.g., producing granddaughter channels, great-granddaughter channels, etc. In some cases, there may also be more than one inlet channel present.

The fluid entering an intersection through the inlet channel may, in some cases, contain one or more droplets (“parent droplets”). If more than one droplet is present, the droplets may be of the same or different sizes, e.g., as discussed below. A droplet may enter the intersection and be split to produce two, three, four, or more daughter droplets, which may then exit the intersection through the daughter channels. The daughter droplets may be of the same or different sizes or diameters. For example, a parent droplet may be split to produce a first droplet and a second droplet. In some embodiments, the first droplet enters a first daughter channel and the second droplet enters a second daughter channel. In other embodiments, however, more than one droplet may exit through a particular daughter channel.

Any suitable technique may be used to split the parent droplet at the intersection. For example, electric charges or induced dipoles may be used to split the parent droplet, e.g., as discussed in U.S. patent application Ser. No. 11/246,911, filed Oct. 7, 2005, entitled “Formation and Control of Fluidic Species,” by Link, et al., published as U.S. Patent Application Publication No. 2006/0163385 on Jul. 27, 2006 or U.S. patent application Ser. No. 11/360,845, filed Feb. 23, 2006, entitled “Electronic Control of Fluidic Species,” by Link, et al., published as U.S. Patent Application Publication No. 2007/0003442 on Jan. 4, 2007, each incorporated herein by reference. Other splitting techniques are also discussed in these references, which may be used in certain embodiments of the present invention. In certain embodiments, a parent droplet may be impacted into an obstacle, which can be used to split the parent droplet into daughter droplets. In some cases, more than obstacle may be used, e.g., to split a parent droplet into 3, 4, 5, or more daughter droplets.

The obstacle may be, for example, any structure that at least partially protrudes into a channel, or in some cases, the obstacle may be an intersection or junction of two or more daughter channels in the inlet channel. As a non-limiting example, the obstacle may be defined as an angle between two planes, e.g., planes 37 and 39 in FIG. 1A, defined as part of channels 11 and 12, respectively. As other examples, the obstacle may be a structure protruding into a channel, e.g., as in a post or a peg, and the obstacle may have any suitable shape, for example, cylindrical, rectangular, pyramidal, conical, spherical, amorphous, etc. The obstacle may protrude partway into the channel or completely cross the channel (e.g., such that it is in contact with two opposing walls of the channel). Non-limiting examples of various obstacles are shown in FIGS. 1A and 3. FIG. 1A illustrates an embodiment where obstacle 18 used to split parent droplet 20 into two separate daughter droplets 21, 22 is a junction of first channel 11 and second channel 12. However, in FIG. 3A, a separate obstacle 27 is used to split parent droplet 20 in inlet channel 15 into two separate daughter droplets 21, 22, which flow into first channel 11 and second channel 12, respectively. In this example, obstacle 27 is a cylindrical post. FIG. 3B illustrates another example where two obstacles 27, 28 are used to split parent droplet 20 in inlet channel 15 into three separate daughter droplets 21, 22, 23, which flow into first channel 11, second channel 12, and third channel 13, respectively.

As mentioned, in certain embodiments, the linear flow rates (or equivalently, the “velocity”) of the fluids and/or the droplets through the channels may be controlled. For example, a parent droplet may flow through an inlet channel at a first linear flow rate (or velocity), and may be split into at least first and second (daughter) droplets, which each respectively enter first and second channels, e.g., such that the first droplet flows at a first velocity within the first channel and the second droplet flows at a second velocity within the second microfluidic channel. The first velocity and the second velocity can be the same or different, and in some cases, can be controlled as discussed below.

In one set of embodiments, the velocities of the parent droplet in the inlet channel and the velocities of the daughter droplets in the daughter channels may be controlled such that there is no significant alteration in overall velocity as the parent droplet passes through the intersection and is split into daughter droplets. For instance, the velocities of the parent and/or daughter droplets may be controlled such that the difference in velocities between the fastest and slowest of all of the velocities is no more than about 50%, no more than about 40%, no more than about 30%, no more than about 20%, no more than about 15%, no more than about 10%, no more than about 5%, no more than about 3%, or no more than about 1% of the initial velocity of the parent droplet. In one set of embodiments, the velocities of the daughter droplets in the daughter channels are substantially equal to each other, and/or are substantially equal to the velocity of the parent droplet in the inlet channel.

In some instances, the Capillary numbers of the parent droplet in the inlet channel and the Capillary numbers of the daughter droplets in the daughter channel may be controlled such that there is no significant alteration in Capillary number as the parent droplet passes through the intersection and is split into daughter droplets. For instance, the Capillary number may be controlled such that the difference in velocities between the fastest and slowest of all of the Capillary numbers of the parent and/or daughter droplets in the various microfluidic channels is no more than about 50%, no more than about 40%, no more than about 30%, no more than about 20%, no more than about 15%, no more than about 10%, no more than about 5%, no more than about 3%, or no more than about 1% of the Capillary number of the parent droplet. In one set of embodiments, the Capillary numbers of the daughter droplets in the daughter channels are substantially equal to each other, and/or substantially equal to the Capillary number of the parent droplet in the inlet channel.

In another set of embodiments, however, the velocities and/or the Capillary numbers of the daughter droplets in the daughter channels may not necessarily be the same. For instance, a difference in hydrodynamic fluid resistances between various daughter channels may cause a difference in partitioning of the parent droplet into different daughter droplets, and/or a difference in hydrodynamic fluid resistances may cause differences in velocities and/or the Capillary numbers of the daughter droplets in the daughter channels. This can be thought of as being analogous to Ohm's Law, where the relative volumes of the droplets produced are equivalent to electrical current, the relative hydrodynamic fluid resistances of the various daughter channels are equivalent to electrical resistance, and the electric voltage is equivalent to the pressure drop needed to cause fluid flow. Accordingly, if an inlet channel is divided into two daughter channels having the same hydrodynamic fluid resistance, then the daughter droplets produced by splitting the parent droplet as discussed above may have the same volume. However, as another non-limiting example, if a first daughter channel has a resistance twice the resistance of a second daughter channel, then a parent droplet split into first and second droplets for flow into each respective channel may be split such that the volume of the first droplet is half the volume of the second droplet. In addition, this control is not limited to only splitting a parent droplet into two daughter droplets, but also into three daughter droplets, four daughter droplets, etc. In some instances, the degree or amount to which a parent droplet is split into daughter droplets (e.g., the volumes of the daughter droplets relative to the parent droplet) may be readily estimated using the relative hydrodynamic fluid resistances of the various daughter channels and application of Ohm's Law.

It should be understood, accordingly, that by controlling the hydrodynamic fluid resistances of the daughter channels, the volumes or sizes of the daughter droplets produced by splitting a parent droplet may be readily controlled. The hydrodynamic fluid resistances of the daughter channels may be controlled, for example, by controlling the dimensions of the daughter channels (e.g., by controlling the length, height, width, cross-sectional area, etc.), by applying a coating to one or more of the daughter channels, by opening or closing a valve within one or more of the daughter channels (see, e.g., International Patent Application No. PCT/US2009/003024, filed May 15, 2009, entitled “Valves and Other Flow Control in Fluidic Systems Including Microfluidic Systems,” by Abate, et al., published as WO 2009/139898 on Nov. 19, 2009, incorporated herein by reference), or the like to thereby control the hydrodynamic fluid resistances of the various daughter channels (in some embodiments, the resistances may be independently controlled). In some cases, the hydrodynamic fluid resistance of a channel may be actively controlled, e.g., while droplet production is occurring, to control the volume of daughter droplets being produced within the device. In certian embodiments, the resistance may be passively controlled, e.g., before starting droplet production. For example, the daughter channels may be designed to have substantially the same hydrodynamic fluid resistances, or different fluid resistances. A combination of these and/or other techniques may be used in some cases.

As mentioned, in one aspect, the hydrodynamic fluid resistances of the daughter channels may be controlled, for example, by controlling the dimensions of the daughter channels. For example, the length, height, width, shape, cross-sectional area, etc. of the daughter channels may be controlled. In one set of embodiments, for instance, the areas of the daughter channels may be controlled such that the sum of their cross-sectional areas, at the intersection with an inlet channel, is substantially the same as the cross-sectional area of the inlet channel at that intersection. For example, the difference in cross-sectional areas between the inlet channel and the sum of the cross-sectional areas of the daughter channels may be no more than about 50%, no more than about 45%, no more than about 40%, no more than about 35%, no more than about 30%, no more than about 25%, no more than about 20%, no more than about 15%, no more than about 10%, no more than about 5%, no more than about 3%, or no more than about 1% of the cross-sectional area of the inlet channel. In addition, in certain embodiments, two or more of the daughter channels may have substantially the same cross-sectional areas and/or shapes.

The area may be controlled, in certain embodiments, by changing or controlling only the heights of the channels, only the widths, or both the height and the widths. In other embodiments, other techniques may also be used as discussed herein, e.g., changing or controlling the shape of the channel. For instance, the channels may have substantially the same heights, but different widths (for example, so that the sum of the widths of the daughter channels is substantially equal to the width of the inlet channel); or the channels may have substantially the same widths, but different heights (for example, so that the sum of the heights of the daughter channels is substantially equal to the height of the inlet channel). Other methods may also be used to change or control area (e.g., changing or controlling the shape of one or more of the channels), including combinations of these and/or other techniques.

As a specific non-limiting example, in one set of embodiments, one or more of the daughter channels may have substantially the same height as the inlet channel, although the daughter channels may have different widths. Such control may be particularly useful, for example, in embodiments where the channels are defined in a substrate, such as a polymeric substrate, where the channels are generally laid out in a plane within the substrate. For instance, in one set of embodiments, for one or more intersections, the difference between the width (or height) of the inlet channel and the sum of the widths (or heights) of the daughter channels may be no more than about 50%, no more than about 45%, no more than about 40%, no more than about 35%, no more than about 30%, no more than about 25%, no more than about 20%, no more than about 15%, no more than about 10%, no more than about 5%, no more than about 3%, or no more than about 1% of the width (or height) of the inlet channel.

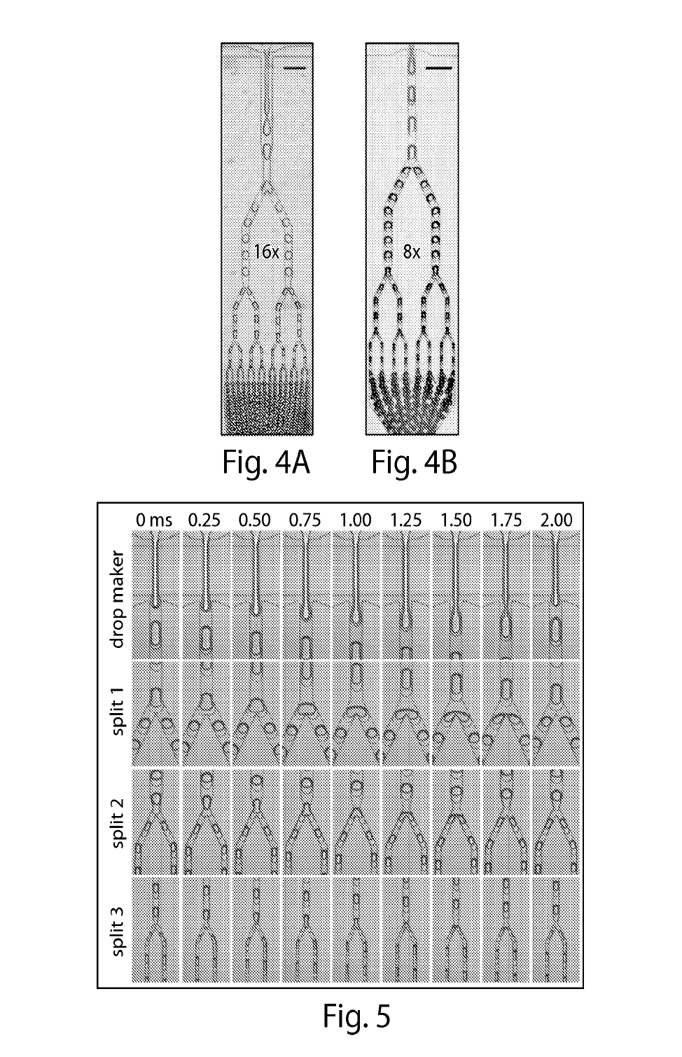

In some embodiments, a fluid channel may narrow somewhat upon reaching a splitting junction. For example, the height and/or width of the channel may narrow by at least about 5%, at least about 10%, at least about 15%, at least about 20%, at least about 25%, at least about 30%, at least about 35%, at least about 40%, at least about 45%, or at least about 50% upon reaching a splitting junction. See, for example, FIG. 5. Such narrowing may be useful, in certain embodiments, to aid in the splitting of droplets, as is discussed in Example 4.

As mentioned, by controlling the hydrodynamic fluid resistances of one or more of the daughter channels, the splitting of a parent droplet into two or more daughter droplets may be controlled. Thus, in another aspect of the invention, a parent droplet may be split as desired into two or more droplets. For example, in one set of embodiments, a parent droplet may be split into two droplets having substantially the same volume and/or size. For instance, by controlling the hydrodynamic fluid resistances as discussed above, the splitting of a parent droplet into daughter droplets, granddaughter droplets, great-granddaughter droplets, etc. may be achieved such that the population of droplets that are produced have a coefficient of variation in volume and/or size of no more than about 50%, no more than about 45%, no more than about 40%, no more than about 35%, no more than about 30%, no more than about 25%, no more than about 20%, no more than about 15%, no more than about 10%, no more than about 5%, no more than about 3%, or no more than about 1%. In some embodiments, a parent droplet may be split into at least first and second droplets such that the difference in volumes between the first droplet and the second droplet is no more than about 50%, no more than about 45%, no more than about 40%, no more than about 35%, no more than about 30%, no more than about 25%, no more than about 20%, no more than about 15%, no more than about 10%, no more than about 5%, no more than about 3%, or no more than about 1% of the greater of the volumes of the first and second droplets.

In some cases, the droplets may have a distribution in diameters or volume such that at least about 50%, at least about 60%, at least about 70%, about 80%, at least about 85%, at least about 90%, at least about 95%, at least about 97%, or at least about 99% of the droplets have a diameter or volume that is no more than about 10% different, no more than about 7% different, no more than about 5% different, no more than about 4% different, no more than about 3% different, no more than about 2% different, or no more than about 1% different from the average diameter or volume of the droplets. The diameter of a non-spherical droplet may be taken as the diameter of a perfect mathematical sphere having the same volume as the non-spherical droplet.

In some embodiments, a single droplet may be spilt to form a plurality of monodisperse droplets. For example, a single droplet may be split into at least 2, 2², 2³, 2⁴, 2⁵, 2⁶, 2⁷, 2⁸, 2⁹, or 2¹⁰ or more monodisperse droplets, or other droplets having characteristics such as those described herein. In addition, as discussed below, the droplets of a monodisperse plurality of parent droplets may each be split to form a plurality of monodisperse droplets or other droplets having characteristics such as those described herein.

The daughter droplets may be of any shape or size. For example, the average diameter of the droplets that are formed may be less than about 1 cm. In certain embodiments, as non-limiting examples, the average diameter of the droplets can also be less than about 1 mm, less than about 500 micrometers, less than about 200 micrometers, less than about 100 micrometers, less than about 75 micrometers, less than about 50 micrometers, less than about 25 micrometers, less than about 20 micrometers, less than about 15 micrometers, less than about 10 micrometers, less than about 5 micrometers, less than about 3 micrometers, less than about 2 micrometers, less than about 1 micrometer, less than about 500 nm, less than about 300 nm, less than about 100 nm, or less than about 50 nm. The average diameter of the droplets may also be at least about 30 nm, at least about 50 nm, at least about 100 nm, at least about 300 nm, at least about 500 nm, at least about 1 micrometer, at least about 2 micrometers, at least about 3 micrometers, at least about 5 micrometers, at least about 10 micrometers, at least about 15 micrometers, or at least about 20 micrometers in certain cases. The “average diameter” of a population of droplets is the arithmetic average of the diameters of the droplets.

As previously discussed, in accordance with one aspect of the invention, a daughter channel may itself serve as an inlet channel of a downstream intersection. Such systems may be used to further split daughter droplets into granddaughter droplets, great-granddaughter droplets, etc. As mentioned, each “splitting” of an inlet channel into two, three, four, or more daughter channels may be termed a “generation”; thus, a device may include any number of generations to split a parent droplet. For instance, at least 2, 3, 4, 5, 6, 7, 8, 9, or 10 or more generations may be present in a device to split a parent droplet, in accordance with various embodiments. For instance, a device may include a network of channels that receives droplets from an inlet channel, where the network of channels may include at least 1 generation of splitting junctions, at least 2 generations, at least 3 generations, at least 4 generations, at least 5 generations, at least 6 generations, etc. If a generation is an inlet channel ending at an intersection with at least two daughter channels, then such a network can be used to generate, for example, 2, 2², 2³, 2⁴, 2⁵, 2⁶, 2⁷, 2⁸, 2⁹, or 2¹⁰ or more daughter droplets from a parent droplet.

In some cases, for each generation, a droplet may be split as discussed above. Thus, as non-limiting examples, a parent droplet may be split into two monodisperse daughter droplets, which may be split into 4 (2²) monodisperse granddaughter droplets, 8 (2³) monodisperse great-granddaughter droplets, etc. (or other numbers of daughter droplets, as previously described); a parent droplet may be split into any number of droplets having a coefficient of variation in volume and/or size of no more than about 50%, no more than about 45%, no more than about 40%, no more than about 35%, no more than about 30%, no more than about 25%, no more than about 20%, etc., as described above; a parent droplet may be split into any number of droplets such that, for each split for each generation, the difference in volumes between the first droplet and the second droplet is no more than about 25%, no more than about 20%, etc., of the greater of the volumes of the first and second droplets (as described above); a parent droplet may be split into any number of droplets such that the droplets may have a distribution in diameters or volume such that at least about 50%, at least about 60%, at least about 70%, at least about 80%, at least about 90%, at least about 95%, etc. have a diameter or volume that is no more than about 10% different, no more than about 7% different, no more than about 5% different, no more than about 3% different, no more than about 1% different, etc. different from the average diameter or volume of the droplets (as described above); or the like.

In some aspects of the invention, the fluid forming the droplets is contained within a second or carrying fluid. These fluids can be miscible or immiscible. For example, the fluids may be immiscible within the time frame of formation of a stream of fluids (e.g., within the time frame of forming droplets), or within the time frame of reaction or interaction within a channel. As used herein, two fluids are “immiscible,” or not miscible, with each other when one is not soluble in the other to a level of at least 10% by weight at the temperature and under the conditions at which the fluids are exposed to each other.

The fluids may be hydrophilic or hydrophobic. For example, in one set of embodiments, a first fluid may be hydrophilic and a second fluid may be hydrophobic, a first fluid may be hydrophobic and a second fluid may be hydrophilic, or both fluids may each be hydrophilic or hydrophobic, etc. More than two fluids can be used in some embodiments. A hydrophobic fluid is generally immiscible in pure water, while a hydrophilic fluid is generally miscible in pure water (of course, water is miscible in itself, and thus, water is a hydrophilic fluid).

As used herein, the term “fluid” generally refers to a substance that tends to flow and to conform to the outline of a container. Typically, fluids are materials that are unable to withstand a static shear stress, and when a shear stress is applied, the fluid experiences a continuing and permanent distortion. The fluid can have any suitable viscosity that permits at least some flow of the fluid. Non-limiting examples of fluids include liquids and gases, but may also include free-flowing solid particles, viscoelastic materials, and the like.

In some cases, one or more of the fluids within a droplet may contain a species such as chemical, biochemical, or biological entities, cells, particles, beads, gases, molecules, pharmaceutical agents, drugs, DNA, RNA, proteins, fragrance, reactive agents, biocides, fungicides, preservatives, chemicals, or the like. Additional non-limiting examples of species that may be present include, for example, biochemical species such as nucleic acids such as siRNA, RNAi and DNA, proteins, peptides, or enzymes. Still other examples of species include, but are not limited to, nanoparticles, quantum dots, fragrances, proteins, indicators, dyes, fluorescent species, chemicals, or the like. Thus, the species can be any substance that can be contained in a fluid and can be differentiated from the fluid containing the species. For example, the species may be dissolved or suspended in the fluid. If the fluids contain droplets, the species can be present in some or all of the droplets.

In one aspect, there may be one, two, three, or more channels arranged in a “flow focusing” configuration in the device, e.g., in which a first fluid in a first channel is sheathed or surrounded by a second fluid delivered using additional channels (e.g., a second channel, and sometimes a third channel or additional channels) in order to cause the first fluid to form discrete droplets contained within the second fluid. The first fluid and the second fluid can be miscible or immiscible. Channel configurations to create such discrete droplets may be found, for example, in U.S. patent application Ser. No. 11/024,228, filed Dec. 28, 2004, entitled “Method and Apparatus for Fluid Dispersion,” by Stone, et al., now U.S. Pat. No. 7,708,949, issued May 4, 2010, incorporated herein by reference in its entirety. The channels may be microfluidic channels in some embodiments. In other embodiments, however, larger channels may be used, e.g., to create larger droplets. For example, in one set of embodiments, one or more parent droplets may be created that have a volume of at least about 0.001 mm³ per droplet, at least about 0.003 mm³ per droplet, at least about 0.005 mm³ per droplet, at least about 0.01 mm³ per droplet, at least about 0.03 mm³ per droplet, at least about 0.05 mm³ per droplet, at least about 0.1 mm³ per droplet, at least about 0.3 mm³ per droplet, at least about 0.5 mm³ per droplet, at least about 1 mm³ per droplet, at least about 3 mm³ per droplet, at least about 5 mm³ per droplet, at least about 10 mm³ per droplet, at least about 30 mm³ per droplet, at least about 50 mm³ per droplet, or at least about 100 mm³ per droplet in some cases. Larger parent droplets may be useful, in some cases, because such droplets can be split into more daughter droplets, e.g., increasing the overall net throughput of droplets produced, and/or promoting uniformity in composition between daughter droplets.

In some cases, a plurality of parent droplets may be produced that are substantially monodisperse, e.g., using techniques such as the flow-focusing techniques described above. For example, the plurality of parent droplets may have a coefficient of variation in volume and/or size of no more than about 50%, no more than about 45%, no more than about 40%, no more than about 35%, no more than about 30%, no more than about 25%, no more than about 20%, no more than about 15%, no more than about 10%, no more than about 5%, no more than about 3%, or no more than about 1%. In some embodiments, the plurality of parent droplets may have a distribution in diameters or volume such that at least about 50%, at least about 60%, at least about 70%, about 80%, at least about 85%, at least about 90%, at least about 95%, at least about 97%, or at least about 99% of the droplets have a diameter or volume that is no more than about 10% different, no more than about 7% different, no more than about 5% different, no more than about 4% different, no more than about 3% different, no more than about 2% different, or no more than about 1% different from the average diameter or volume of the parent droplets. The plurality of parent droplets may then be spilt, e.g., into at least a plurality of first droplets and a plurality of second droplets. In some cases, the plurality of first droplets may be substantially monodisperse and/or the plurality of second droplets may be substantially monodisperse, or the plurality of first and/or second droplets may have a coefficient of variation in volume and/or size such as those described above.

As a non-limiting example of a flow focusing configuration, there may be a first channel having an opening, and second and third channels each intersecting the first channel at a common intersection. (In other embodiments of the invention, there may be more or fewer additional channels present.) Fluid within the second and third channels can arise from a common source of fluid or from two different sources of fluid, and the fluids within the second and third channels can be the same or different. One or both of the second channel and the third channel may each meet the first channel at a substantially right angle, or at another suitable angle. In some cases, the second channel and the third channel may meet the first channel substantially opposite of each other, although in other cases, the channels may not all intersect at the same intersection.

In certain aspects, a double emulsion droplet or other multiple emulsion droplet may be formed and then split. A double emulsion droplet typically includes an inner fluid droplet, surrounded by an outer fluid droplet, which in turn is surrounded by a third or carrying fluid. Non-limiting examples of configurations for creating double or other multiple emulsions may be seen in U.S. patent application Ser. No. 11/885,306, filed Aug. 29, 2007, entitled “Method and Apparatus for Forming Multiple Emulsions,” by Weitz, et al., published as U.S. Patent Application Publication No. 2009/0131543 on May 21, 2009, or U.S. patent application Ser. No. 12/058,628, filed Mar. 28, 2008, entitled “Emulsions and Techniques for Formation,” by Chu, et al., now U.S. Pat. No. 7,776,927, issued Aug. 17, 2010, each incorporated herein by reference in its entirety. Other suitable techniques for preparing double emulsions are disclosed in International Patent Application No. PCT/US2010/000763, filed Mar. 12, 2010, entitled “Controlled Creation of Multiple Emulsions,” by Weitz, et al., published as WO 2010/104604 on Sep. 16, 2010; or International Patent Application No. PCT/US2010/047458, filed Sep. 1, 2010, entitled “Multiple Emulsions Created Using Junctions,” by Weitz, et al., each incorporated herein by reference in its entirety.

In some embodiments, a double or other multiple emulsion may be split, e.g., using an obstacle. In some cases, surprisingly, the double emulsion may be relatively uniformly split into two daughter droplets, e.g., such that each daughter droplet has substantially the same size and composition, i.e., including substantially the same volumes of inner fluid(s) and outer fluid. For instance, a double emulsion droplet may be split into a first double emulsion droplet and a second double emulsion droplet, e.g., such that about 50% of the inner fluid in the parent double emulsion droplet is split into the first droplet, and about 50% of the inner fluid is split into the second droplet, and/or about 50% of the outer fluid in the parent double emulsion droplet is split into the first droplet, and about 50% of the outer fluid is split into the second droplet. In other embodiments, however, other volumetric splits of the double emulsion droplet may occur, e.g., by controlling the relative hydrodynamic fluid resistances of the channels used to form the droplets. In addition, in sill other embodiments, a double emulsion droplet may be split into three, four, or more daughter droplets, and in some cases, such that the inner fluid(s) and outer fluids are also split substantially evenly between the daughter droplets.

Certain aspects of the invention are generally directed to devices containing channels and generations of channels such as those described herein. In some cases, some of the channels may be microfluidic channels, but in certain instances, not all of the channels are microfluidic. For example, in one set of embodiments, one or more parent droplets may be created that have a volume of at least about 0.001 mm³, at least about 0.01 mm³, at least about 0.1 mm³, or at least about 1 mm³ per droplet. Such droplets may be created in channels that are not microfluidic channels. The droplets may be split multiple times, as discussed herein, for example, to produce daughter droplets that are contained within microfluidic channels and/or have microfluidic diameters.

Thus, there can be any number of channels, including microfluidic channels, within the device, and the channels may be arranged in any suitable configuration. The channels may be all interconnected, or there can be more than one network of channels present. The channels may independently be straight, curved, bent, etc. In some cases, there may be a relatively large number and/or a relatively large length of channels present in the device. For example, in some embodiments, the channels within a device, when added together, can have a total length of at least about 100 micrometers, at least about 300 micrometers, at least about 500 micrometers, at least about 1 mm, at least about 3 mm, at least about 5 mm, at least about 10 mm, at least about 30 mm, at least 50 mm, at least about 100 mm, at least about 300 mm, at least about 500 mm, at least about 1 m, at least about 2 m, or at least about 3 m in some cases. As another example, a device can have at least 1 channel, at least 3 channels, at least 5 channels, at least 10 channels, at least 20 channels, at least 30 channels, at least 40 channels, at least 50 channels, at least 70 channels, at least 100 channels, etc.

In some embodiments, at least some of the channels within the device are microfluidic channels. “Microfluidic,” as used herein, refers to a device, article, or system including at least one channel having a cross-sectional dimension of less than about 1 mm. The “cross-sectional dimension” of the channel is measured perpendicular to the direction of net fluid flow within the channel. Thus, for example, some or all of the channels in a device can have a maximum cross-sectional dimension less than about 2 mm, and in certain cases, less than about 1 mm. In one set of embodiments, all of the channels in a device are microfluidic and/or have a largest cross sectional dimension of no more than about 2 mm or about 1 mm. In certain embodiments, some or all of the channels may be formed in part by a single component (e.g. an etched substrate or molded unit). Of course, larger channels, tubes, chambers, reservoirs, etc. can be used to store fluids and/or deliver fluids to various elements or systems in other embodiments of the invention, for example, as previously discussed. In one set of embodiments, the maximum cross-sectional dimension of the channels in a device is less than about 500 micrometers, less than about 200 micrometers, less than about 100 micrometers, less than about 50 micrometers, or less than about 25 micrometers. In other embodiments, however, larger channels may also be present.

A “channel,” as used herein, means a feature on or in a device or substrate that at least partially directs flow of a fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlets and/or outlets or openings. A channel may also have an aspect ratio (length to average cross sectional dimension) of at least 2:1, more typically at least 3:1, 4:1, 5:1, 6:1, 8:1, 10:1, 15:1, 20:1, or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus).

The channel may be of any size, for example, having a maximum dimension perpendicular to net fluid flow of less than about 5 mm or 2 mm, or less than about 1 mm, less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases, the dimensions of the channel are chosen such that fluid is able to freely flow through the device or substrate. The dimensions of the channel may also be chosen, for example, to allow a certain volumetric or linear flow rate of fluid in the channel. Of course, the number of channels and the shape of the channels can be varied by any method known to those of ordinary skill in the art. In some cases, more than one channel may be used. For example, two or more channels may be used, where they are positioned adjacent or proximate to each other, positioned to intersect with each other, etc.

In certain embodiments, one or more of the channels within the device may have an average cross-sectional dimension of less than about 10 cm. In certain instances, the average cross-sectional dimension of the channel is less than about 5 cm, less than about 3 cm, less than about 1 cm, less than about 5 mm, less than about 3 mm, less than about 1 mm, less than 500 micrometers, less than 200 micrometers, less than 100 micrometers, less than 50 micrometers, or less than 25 micrometers. The “average cross-sectional dimension” is measured in a plane perpendicular to net fluid flow within the channel. If the channel is non-circular, the average cross-sectional dimension may be taken as the diameter of a circle having the same area as the cross-sectional area of the channel. Thus, the channel may have any suitable cross-sectional shape, for example, circular, oval, triangular, irregular, square, rectangular, quadrilateral, or the like. In some embodiments, the channels are sized so as to allow laminar flow of one or more fluids contained within the channel to occur.

The channel may also have any suitable cross-sectional aspect ratio. The “cross-sectional aspect ratio” is, for the cross-sectional shape of a channel, the largest possible ratio (large to small) of two measurements made orthogonal to each other on the cross-sectional shape. For example, the channel may have a cross-sectional aspect ratio of less than about 2:1, less than about 1.5:1, or in some cases about 1:1 (e.g., for a circular or a square cross-sectional shape). In other embodiments, the cross-sectional aspect ratio may be relatively large. For example, the cross-sectional aspect ratio may be at least about 2:1, at least about 3:1, at least about 4:1, at least about 5:1, at least about 6:1, at least about 7:1, at least about 8:1, at least about 10:1, at least about 12:1, at least about 15:1, or at least about 20:1.

As mentioned, the channels can be arranged in any suitable configuration within the device. Different channel arrangements may be used, for example, to manipulate fluids, droplets, and/or other species within the channels. For example, channels within the device can be arranged to create droplets (e.g., discrete droplets, single emulsions, double emulsions or other multiple emulsions, etc.), to mix fluids and/or droplets or other species contained therein, to screen or sort fluids and/or droplets or other species contained therein, to split or divide fluids and/or droplets, to cause a reaction to occur (e.g., between two fluids, between a species carried by a first fluid and a second fluid, or between two species carried by two fluids to occur), or the like. In some cases, two or more channels are arranged to intersect at one or more intersections. There may be any number of fluidic channel intersections within the device, for example, 2, 3, 4, 5, 6, etc., or more intersections.

Non-limiting examples of systems for manipulating fluids, droplets, and/or other species are discussed below. Additional examples of suitable manipulation systems can also be seen in U.S. patent application Ser. No. 11/246,911, filed Oct. 7, 2005, entitled “Formation and Control of Fluidic Species,” by Link, et al., published as U.S. Patent Application Publication No. 2006/0163385 on Jul. 27, 2006; U.S. patent application Ser. No. 11/024,228, filed Dec. 28, 2004, entitled “Method and Apparatus for Fluid Dispersion,” by Stone, et al., now U.S. Pat. No. 7,708,949, issued May 4, 2010; U.S. patent application Ser. No. 11/885,306, filed Aug. 29, 2007, entitled “Method and Apparatus for Forming Multiple Emulsions,” by Weitz, et al., published as U.S. Patent Application Publication No. 2009/0131543 on May 21, 2009; and U.S. patent application Ser. No. 11/360,845, filed Feb. 23, 2006, entitled “Electronic Control of Fluidic Species,” by Link, et al., published as U.S. Patent Application Publication No. 2007/0003442 on Jan. 4, 2007; each of which is incorporated herein by reference in its entirety.

Fluids may be delivered into channels within a device via one or more sources of fluid. Any suitable source of fluid can be used, and in some cases, more than one source of fluid is used. For example, a pump, gravity, capillary action, surface tension, electroosmosis, centrifugal forces, etc. may be used to deliver a fluid from a source of fluid into one or more channels in the device. Non-limiting examples of pumps include syringe pumps, peristaltic pumps, pressurized sources of fluid, or the like. The device can have any number of sources of fluid associated with it, for example, 1, 2, 3, 4, 5, 6, 7, 8, 9, 10, etc., or more sources of fluid. The sources of fluid need not be used to deliver fluid into the same channel, e.g., a first source of fluid can deliver a first fluid to a first channel while a second source of fluid can deliver a second fluid to a second channel, etc.

A variety of materials and methods, according to certain aspects of the invention, can be used to form devices or components such as those described herein, e.g., channels such as microfluidic channels, chambers, etc. For example, various devices or components can be formed from solid materials, in which the channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al).

In one set of embodiments, various structures or components of the devices described herein can be formed of a polymer, for example, an elastomeric polymer such as polydimethylsiloxane (“PDMS”), polytetrafluoroethylene (“PTFE” or Teflon®), or the like. For instance, according to some embodiments, a microfluidic channel may be implemented by fabricating the fluidic system separately using PDMS or other soft lithography techniques (details of suitable soft lithography techniques are discussed in the references entitled “Soft Lithography,” by Younan Xia and George M. Whitesides, published in the Annual Review of Material Science, 1998, Vol. 28, pages 153-184, and “Soft Lithography in Biology and Biochemistry,” by George M. Whitesides, Emanuele Ostuni, Shuichi Takayama, Xingyu Jiang and Donald E. Ingber, published in the Annual Review of Biomedical Engineering, 2001, Vol. 3, pages 335-373; each of these references is incorporated herein by reference).

Other examples of potentially suitable polymers include, but are not limited to, polyethylene terephthalate (PET), polyacrylate, polymethacrylate, polycarbonate, polystyrene, polyethylene, polypropylene, polyvinylchloride, cyclic olefin copolymer (COC), polytetrafluoroethylene, a fluorinated polymer, a silicone such as polydimethylsiloxane, polyvinylidene chloride, bis-benzocyclobutene (“BCB”), a polyimide, a fluorinated derivative of a polyimide, or the like. Combinations, copolymers, or blends involving polymers including those described above and/or other polymers are also envisioned. The device may also be formed from composite materials, for example, a composite of a polymer and a semiconductor material.

In some embodiments, various structures or components of the device are fabricated from polymeric and/or flexible and/or elastomeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, waxes, metals, or mixtures or composites thereof heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are used in certain embodiments, for example, the silicone elastomer polydimethylsiloxane or PDMS. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of various structures useful in certain embodiments of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric and thus may be useful for forming very small features with relatively high aspect ratios, e.g., in certain embodiments of the invention. Flexible (e.g., elastomeric) molds or masters can be advantageous in this regard.

One advantage of forming structures such as microfluidic structures or channels from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, structures can be fabricated and then oxidized and/or essentially irreversibly sealed to other silicone polymer surfaces, or to the surfaces of other substrates reactive with the oxidized silicone polymer surfaces, in some embodiments without the need for separate adhesives or other sealing means. In certain cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy et al.), incorporated herein by reference.

Another advantage to forming channels or other structures (or interior, fluid-contacting surfaces) from oxidized silicone polymers is that these surfaces can be much more hydrophilic than the surfaces of typical elastomeric polymers (where a hydrophilic interior surface is desired), at least in some embodiments. Such hydrophilic channel surfaces can thus be more easily filled and wetted with aqueous solutions than can structures comprised of typical, unoxidized elastomeric polymers or other hydrophobic materials.

In certain aspects, more than one article containing channels including microfluidic channels may be used, and in some cases, the articles may have channels of different heights or other dimensions. Such articles may be useful, e.g., due to the change in scale going from channels of relatively large size to channels of relatively small size. For instance, a first article may contain one or more generations of splitting junctions, while a second article may contain smaller channels and optionally additional generations of splitting junctions. In such a fashion, a relatively large droplet may be split multiple times (e.g., 2, 3, 4, 5, 6, 7, 8, 9, or 10 or more times) by using channels within the various articles having a decreasing succession in cross-sectional areas. As a specific example, an inlet microfluidic channel may have a height and each of the daughter microfluidic channels may have a height, where the difference in heights between the inlet microfluidic channel and the average of the heights of the daughter microfluidic channels is greater than about 10%, greater than about 15%, greater than about 20% or greater than about 25%, of the height of the inlet microfluidic channel.

As a specific non-limiting example, a first article may contain a first network of channels, and some or all of the channels may be directed to or in fluid communication with a second article containing a second network of channels. In some cases, the channels within the first article may be at a first height, while the channels within the second article may be at a second height, where the first and second heights may be the same or different. In some cases, the difference in heights between the first article and the second article may be greater than about 10%, greater than about 15%, greater than about 20% or greater than about 25%, of the height of the channels within the first article.

In some aspects, one or more walls or portions of a channel may be coated, e.g., with a coating material. Examples of systems and methods for coating microfluidic channels, for example, with sol-gel coatings or photoactive coating materials, may be seen in International Patent Application No. PCT/US2009/000850, filed Feb. 11, 2009, entitled “Surfaces, Including Microfluidic Channels, With Controlled Wetting Properties,” by Abate, et al., published as WO 2009/120254 on Oct. 1, 2009, and International Patent Application No. PCT/US2008/009477, filed Aug. 7, 2008, entitled “Metal Oxide Coating on Surfaces,” by Weitz, et al., published as WO 2009/020633 on Feb. 12, 2009, each incorporated herein by reference in its entirety.

In some cases, some or all of the channels may be coated, or otherwise treated such that some or all of the channels, including the inlet and daughter channels, each have substantially the same hydrophilicity. The coating materials can be used in certain instances to control and/or alter the hydrophobicity of the wall of a channel. In some embodiments, a sol-gel is provided that can be formed as a coating on a substrate such as a wall of a channel such as a microfluidic channel. One or more portions of the sol-gel can be reacted to alter its hydrophobicity, in some cases. For example, a portion of the sol-gel may be exposed to light, such as ultraviolet light, which can be used to induce a chemical reaction in the sol-gel that alters its hydrophobicity. The sol-gel may include a photoinitiator which, upon exposure to light, produces radicals. Optionally, the photoinitiator is conjugated to a silane or other material within the sol-gel. The radicals so produced may be used to cause a condensation or polymerization reaction to occur on the surface of the sol-gel, thus altering the hydrophobicity of the surface. In some cases, various portions may be reacted or left unreacted, e.g., by controlling exposure to light (for instance, using a mask).

Thus, in one aspect of the invention, a coating on the wall of a channel may be a sol-gel. As is known to those of ordinary skill in the art, a sol-gel is a material that can be in a sol or a gel state. In some cases, the sol-gel material may comprise a polymer. The sol state may be converted into the gel state by chemical reaction. In some cases, the reaction may be facilitated by removing solvent from the sol, e.g., via drying or heating techniques. Thus, in some cases, e.g., as discussed below, the sol may be pretreated before being used, for instance, by causing some condensation to occur within the sol. Sol-gel chemistry is, in general, analogous to polymerization, but is a sequence of hydrolysis of the silanes yielding silanols and subsequent condensation of these silanols to form silica or siloxanes.

In some embodiments, the sol-gel coating may be chosen to have certain properties, for example, having a certain hydrophobicity. The properties of the coating may be controlled by controlling the composition of the sol-gel (for example, by using certain materials or polymers within the sol-gel), and/or by modifying the coating, for instance, by exposing the coating to a condensation or polymerization reaction to react a polymer to the sol-gel coating, as discussed herein.

For example, the sol-gel coating may be made more hydrophobic by incorporating a hydrophobic polymer in the sol-gel. For instance, the sol-gel may contain one or more silanes, for example, a fluorosilane (i.e., a silane containing at least one fluorine atom) such as heptadecafluorosilane or heptadecafluorooctylsilane, or other silanes such as methyltriethoxy silane (MTES) or a silane containing one or more lipid chains, such as octadecylsilane or other CH₃(CH₂)ₙ— silanes, where n can be any suitable integer. For instance, n may be greater than 1, 5, or 10, and in some cases, less than about 20, 25, or 30. The silanes may also optionally include other groups, such as alkoxide groups, for instance, octadecyltrimethoxysilane. Other examples of suitable silanes include alkoxysilanes such as ethoxysilane or methoxysilane, halosilanes such as chlorosilanes, or other silicon-containing compounds containing hydrolyzable moieties on the silicon atom, such as hydroxide moieties. In general, most silanes can be used in the sol-gel, with the particular silane being chosen on the basis of desired properties such as hydrophobicity. Other silanes (e.g., having shorter or longer chain lengths) may also be chosen in other embodiments of the invention, depending on factors such as the relative hydrophobicity or hydrophilicity desired. In some cases, the silanes may contain other groups, for example, groups such as amines, which would make the sol-gel more hydrophilic. Non-limiting examples include diamine silane, triamine silane, or N-[3-(trimethoxysilyl)propyl]ethylene diamine silane. The silanes can be reacted to form networks within the sol-gel, and the degree of condensation may be controlled by controlling the reaction conditions, for example by controlling the temperature, amount of acid or base present, or the like.

In some cases, more than one silane is present in the sol-gel. For instance, the sol-gel can include fluorosilanes to cause the resulting sol-gel to exhibit greater hydrophobicity, and other silanes (or other compounds) that facilitate the production of polymers. In some cases, materials able to produce SiO₂ compounds to facilitate condensation or polymerization may be present, for example, TEOS (tetraethyl orthosilicate). In some embodiments, the silane may have up to four chemical moieties bonded to it, and in some cases, one of the moieties may be an RO— moiety, where R is an alkoxide or other chemical moiety, for example, so that the silane can become incorporated into a metal oxide-based network. In addition, in some cases, one or more of the silanes can be hydrolyzed to form the corresponding silanol.

In addition, it should be understood that the sol-gel is not limited to containing only silanes, and other materials may be present in addition to, or in place of, the silanes. For instance, the coating may include one or more metal oxides, such as SiO₂, vanadia (V₂O₅), titania (TiO₂), and/or alumina (Al₂O₃). As other examples, the sol-gel may comprise moieties containing double bonds, or otherwise are reactive within any polymerization reactions, for example, thiols for participation in radical polymerization.

The sol-gel may be present as a coating on the substrate or wall of a channel, and the coating may have any suitable thickness. For instance, the coating may have a thickness of no more than about 100 micrometers, no more than about 30 micrometers, no more than about 10 micrometers, no more than about 3 micrometers, or no more than about 1 micrometer. Thicker coatings may be desirable in some cases, for instance, in applications in which higher chemical resistance is desired. However, thinner coatings may be desirable in other applications, for instance, within relatively small microfluidic channels.

In one set of embodiments, the hydrophobicity of the sol-gel coating can be controlled, for instance, such that a first portion of the sol-gel coating is relatively hydrophobic, and a second portion of the sol-gel coating is more or less relatively hydrophobic than the first portion. The hydrophobicity of the coating can be determined using techniques known to those of ordinary skill in the art, for example, using contact angle measurements such as those discussed herein. For instance, in some cases, a first portion of a substrate (e.g., within a microfluidic channel, for example, a wall) can have a hydrophobicity that favors an organic solvent to water, while a second portion can have a hydrophobicity that favors water to the organic solvent.

The hydrophobicity of the sol-gel coating can be modified, for instance, by exposing at least a portion of the sol-gel coating to a condensation or polymerization reaction to react a polymer with the sol-gel coating. The polymer reacted to the sol-gel coating may be any suitable polymer, and may be chosen to have certain hydrophobicity properties. For instance, the polymer may be chosen to be more hydrophobic or more hydrophilic than the substrate and/or the sol-gel coating. As an example, a hydrophilic polymer that could be used is poly(acrylic acid).

The polymer may be added to the sol-gel coating by supplying the polymer in monomeric (or oligomeric) form to the sol-gel coating (e.g., in solution), and causing a condensation or polymerization reaction to occur between the polymer and the sol-gel.

For instance, free radical polymerization may be used to cause bonding of the polymer to the sol-gel coating. In some embodiments, a reaction such as free radical polymerization may be initiated by exposing the reactants to heat and/or light, such as ultraviolet (UV) light, optionally in the presence of a photoinitiator able to produce free radicals (e.g., via molecular cleavage) upon exposure to light. Those of ordinary skill in the art will be aware of many such photoinitiators, many of which are commercially available, such as Irgacur 2959 (Ciba Specialty Chemicals), aminobenzophenone, benzophenone, or 2-hydroxy-4-(3-triethoxysilylpropoxy)-diphenylketone (SIH6200.0, ABCR GmbH & Co. KG).

The photoinitiator may be included with the polymer added to the sol-gel coating, or in some cases, the photoinitiator may be present within the sol-gel coating. The photoinitiators can also be introduced within the sol-gel coating after the coating step, in some embodiments. For example, a photoinitiator may be contained within the sol-gel coating, and activated upon exposure to light. The photoinitiator may also be conjugated or bonded to a component of the sol-gel coating, for example, to a silane. As a non-limiting example, a photoinitiator such as Irgacur 2959 can be conjugated to a silane-isocyanate via a urethane bond (where a primary alcohol on the photoinitiator may participate in nucleophilic addition with the isocyanate group, which can produce a urethane bond).

The sol may be contained within a solvent, which can also contain other compounds such as photoinitiators including those described above. In some cases, the sol also comprises one or more silane compounds. The sol may be treated to form a gel using any suitable technique, for example, by removing the solvent using chemical or physical techniques, such as heat. For instance, the sol can be exposed to a temperature of at least about 50° C., at least about 100° C., at least about 150° C., at least about 200° C., or at least about 250° C., which may be used to drive off or vaporize at least some of the solvent. As a specific example, the sol may be exposed to a hotplate set to reach a temperature of at least about 200° C. or at least about 250° C., and exposure of the sol to the hotplate may cause at least some of the solvent to be driven off or vaporized. In some cases, however, the sol-gel reaction may proceed even in the absence of heat, e.g., at room temperature. Thus, for instance, the sol may be left alone for a while (e.g., about an hour, about a day, etc.), and/or air or other gases, or liquids, may be passed over the sol to allow the sol-gel reaction to proceed.

In other embodiments, other techniques of initiation may be used instead of or in addition to photoinitiators. Examples include, but are not limited to, redox initiation, thermal decomposition triggered by e.g. heating portions of a device (e.g., this can be done by liquid streams that have a certain temperature or contain an oxidizing or a reducing chemical). In another embodiment, functionalization of the surfaces may be achieved by polyaddition and/or polycondensation reactions, for instance, if the surface contains reactive groups that can participate in the reaction. Silanes containing a desired functionality can also be added in some cases, e.g., silanes containing COOH moieties, NH₂ moieties, SO₃H moieties, SO₄H moieties, OH moieties, PEG-chains, or the like).

In some cases, any ungelled sol that is still present can be removed from the substrate. The ungelled sol may be actively removed, e.g., physically, by the application of pressure or the addition of a compound to the substrate, etc., or the ungelled sol may be removed passively in some cases. For instance, in some embodiments, a sol present within a microfluidic channel is heated to vaporize solvent, which builds up in a gaseous state within the microfluidic channels, thereby increasing pressure within the microfluidic channels. The pressure, in some cases, may be enough to cause at least some of the ungelled sol to be removed or “blown” out of the microfluidic channels.

In certain embodiments, a portion of the coating may be treated to alter its hydrophobicity (or other properties) after the coating has been introduced to the substrate. In some cases, the coating is exposed to a solution containing a monomer and/or an oligomer, which is then condensed or polymerized to bond to the coating, as discussed above. For instance, a portion of the coating may be exposed to heat or to light such as ultraviolet right, which may be used to initiate a free radical polymerization reaction to cause polymerization to occur. Optionally, a photoinitiator is present, e.g., within the sol-gel coating, to facilitate this reaction. In some embodiments, the photoinitiator can also contain double bonds, thiols, and/or other reactive groups such that the monomers and/or oligomers can be covalently linked to the sol-gel coating.

The following documents are incorporated herein by reference in their entireties: U.S. patent application Ser. No. 11/246,911, filed Oct. 7, 2005, entitled “Formation and Control of Fluidic Species,” by Link, et al., published as U.S. Patent Application Publication No. 2006/0163385 on Jul. 27, 2006; U.S. patent application Ser. No. 11/024,228, filed Dec. 28, 2004, entitled “Method and Apparatus for Fluid Dispersion,” by Stone, et al., now U.S. Pat. No. 7,708,949, issued May 4, 2010; U.S. patent application Ser. No. 11/885,306, filed Aug. 29, 2007, entitled “Method and Apparatus for Forming Multiple Emulsions,” by Weitz, et al., published as U.S. Patent Application Publication No. 2009/0131543 on May 21, 2009; and U.S. patent application Ser. No. 11/360,845, filed Feb. 23, 2006, entitled “Electronic Control of Fluidic Species,” by Link, et al., published as U.S. Patent Application Publication No. 2007/0003442 on Jan. 4, 2007.

Also incorporated herein by reference in its entirety is U.S. Provisional Patent Application Ser. No. 61/440,198, filed Feb. 7, 2011, entitled “Systems and Methods for Splitting Droplets,” by Abate, et al.

The following examples are intended to illustrate certain embodiments of the present invention, but do not exemplify the full scope of the invention.

### EXAMPLE 1

Double emulsions are droplets that contain additional smaller droplets inside. Because of their small dimensions and core-shell structure, they are useful for applications requiring microencapsulation, including foods, cosmetics, and pharmaceuticals. With microfluidic devices, double emulsion droplets can be formed with controlled properties, including controlled dimensions and volume fractions. The droplets can also be efficiently filled with active materials: typically, encapsulations of 100% efficiency can be achieved, whereas, by contrast, bulk methods achieve less than 10% of the actives encapsulated. Nevertheless, there are disadvantages to this approach; an important example results from the small dimensions of the devices, which leads to droplets being formed at very slow rates. Double emulsions are typically only formed only at milliliters per hour, which may be too slow for some applications.

One way to increase throughput is to parallelize the devices. Rather than a single device producing a small quantity of droplets, many devices can be used simultaneously to produce much larger quantities. However, parallelization of double emulsion synthesis is difficult due to the complexity of such devices. While single emulsions can be formed, for example, using only a simple T-junction, double emulsions often require more complex systems, such as cascading T- or cross-channel junctions, sometimes with spatially patterned interfacial wettability.

This example illustrates certain systems and methods to increase, up to several orders of magnitude, the production rate of multiple emulsions with microfluidic devices. This strategy is based on the recognition that the maximum volumetric rate with which a device can form droplets scales with the dimensions of the drop maker nozzle: larger nozzles yield larger volumes of multiple emulsions per unit time. However, the increased dimensions also result in larger droplets, which may be undesirable for some applications. To produce droplets of smaller size, larger droplets are split into small droplets using a splitting array in this example. Each time a droplet flows through a split, it is bisected into two equal portions (although other splitting ratios may be used in other cases). By splitting additional times, even smaller, though still substantially monodisperse, droplets are formed. The splitting is also applicable to single and multiple emulsions.

Without wishing to be bound by any theory, the maximum rate at which a device forms monodisperse droplets may be determined by determining the dripping-to-jetting transition. This can occur for a maximum value of the inner phase flow velocity νᵢₙ. The production rate of the emulsion, however, does not scale with νᵢₙ, but with the volumetric flow rate Uᵢₙ=νᵢₙ A, where A is the cross sectional area of the drop maker or channel. Therefore, even for fixed flow velocity, throughput can be increased by scaling up A. However, this also may result in the production of larger droplets, since, for droplet formation in which plugging effects are important, V_{drop}=w A (1−α Uᵢₙ/Uₒᵤₜ), where V_{drop} is the droplet volume, w is the cross-sectional width of the drop maker nozzle, α (alpha) is a geometrical parameter close to one, and Uₒᵤₜ is the flow rate of the outer phase. Based on this, Dₛₚₕₑᵣₑ˜(w A)^{1/3}. To obtain droplets of the desired small size, the droplets are split into small substantially monodisperse droplets using a splitting array in this example.

This splitting array includes a series of channels that each divide into two channels several times. When a droplet encounters one of the splitting junctions, viscous and pressure forces pull it down each branch. Depending on flow conditions, channel dimensions, and the interfacial tension of the fluids, the droplet can either choose one path, remaining intact, or follow both paths, splitting in two. If the droplet splits, the size of the resultant droplets may depend on the hydrodynamic resistances of the branches after the splitting junction. For equal resistances, the droplets may be split evenly, resulting in a substantially monodisperse emulsion containing twice as many droplets of half the original volume. Additional splitting junctions or “generations” can be added to produce smaller droplets. Each split or generation halves the volume, so that every three divisions halves the effective diameter. This allows selection of the final droplet size by choosing the number of splitting junctions or generations. Moreover, the rate of splitting is not limited by the final size of the droplets, since with each split, channels are added; this is, in essence, a form of parallelization, though the parallelization occurs after the droplets have been formed.

To illustrate the use of splitting for increased production, in this example, a substantially monodisperse single emulsion was created at high throughput. Water was used for the droplet phase and HFE-7500 (3M) was used as a fluorocarbon oil, with the ammonium salt of Krytox® 157 FSL (DuPont) at 1.8 wt % as a surfactant, for the continuous phase. To enable production of water-in-oil droplets, the device channels were rendered hydrophobic by treating with Aquapel® (PPG Industries). This was achieved in this example by flushing Aquapel® through the device for a few seconds, flushing with air, and then baking the device at 65° C. for 20 min.

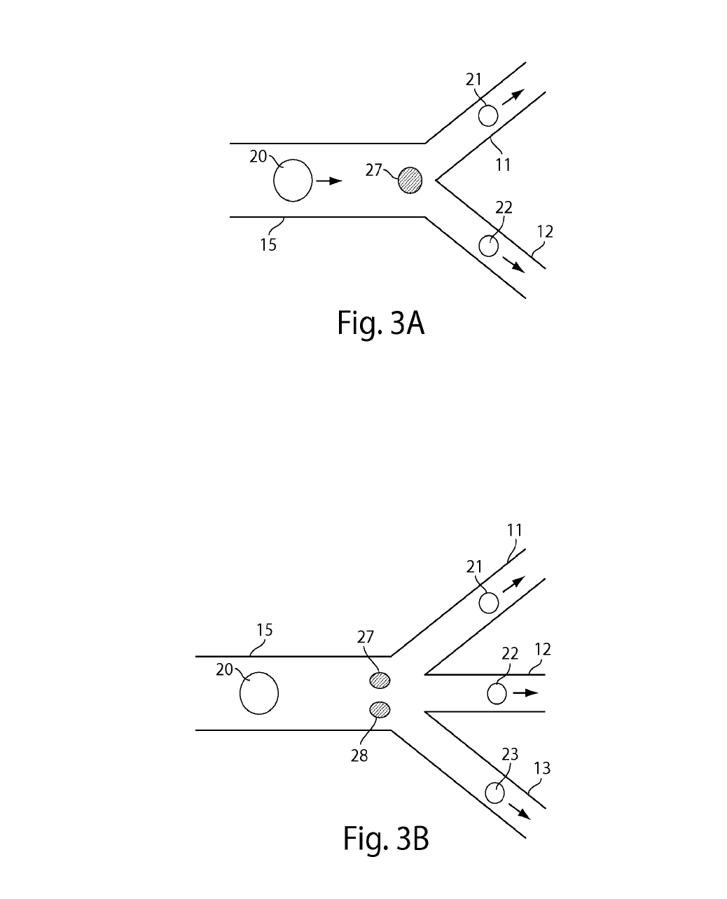

The water and oil were injected into the device and met at a cross-channel junction, where a water jet was formed, as shown in the upper portion of FIG. 4A, which shows a single emulsion device. The device was fabricated in poly(dimethylsiloxane) using the techniques of soft lithography, as discussed herein. The single emulsion device operated at a throughput that was roughly 10x faster than a conventional drop maker. Since the flow rates were close to the dripping-to-jetting transition, the jet was unstable, having ripples on its interface that were on the verge of breaking it into droplets. Normally, the jet would break randomly, producing polydisperse droplets; however, by adding a constriction downstream, the jet was induced to break into substantially monodisperse droplets, as shown in this figure. Due to the dimensions of the nozzle, 50 micrometers in height and 120 micrometers in width, the resultant droplets were relatively large, with diameters of about 88 micrometers if treated as a sphere. To produce droplets of the desired 35 micrometers in diameter or size, the large droplets were split (88 micrometers/35 micrometers)³˜4 times, into 2⁴=16 equal portions. The maximum production rate of this device was therefore about 7,000 microliters/h; to produce droplets of this size directly would typically require a nozzle of dimensions 25 micrometers in height and 25 micrometers in width, having a maximum rate of only ˜600 microliters/h.

### EXAMPLE 2

Splitting can also be used to increase the rate of production of double emulsification droplets. In this example, a splitting array was added to the end of a large drop maker, e.g., as discussed in Example 1, though this time it was a double emulsion maker. The double emulsion device included two cross-channel junctions connected in series, as shown in FIG. 4B and the upper row of images in FIG. 5. The device was fabricated in poly(dimethylsiloxane) using the techniques of soft lithography, as discussed herein. The double emulsion device operated ˜5× faster than a conventional drop maker; the slower speed of the double emulsion device, relative to the device of Example 1, was due to the fewer number of splitting junctions.

FIG. 5 illustrates image sequences of double emulsions being formed using one-step double emulsification (top row) and being split into smaller droplets using splitting junctions (lower rows). The device bisected the double emulsions three times into daughter droplets with volumes ⅛^{th} of the original parent droplet. The splitting junctions narrowed after each stage, to allow effective splitting of the smaller droplets. The final droplets were about 43 micrometers in diameter if treated as a sphere.

To make the double emulsions, octanol, water with SDS (sodium dodecyl sulfate) at 1 wt %, and HFE-7500 with the Krytox® surfactant at 1.8 wt %, were injected into the inner, middle, and continuous phase inlets, at 200 microliters/h, 500 microliters/h, and 1000 microliters/h, respectively. This formed a stable jet of octanol in water in the first junction, which entered the second junction where the oil was added. This created a coaxial jet of octanol surrounded by a sheath of water, which itself was surrounded by oil.

As the coaxial jet entered the second junction, it became unstable, causing the outer interface to narrow, squeezing the octanol jet. When the coaxial jet reached an unstable width, it snapped, producing a double emulsion of a water droplet with an octanol core, as shown in the upper row of FIG. 5. This “one-step” pinching is distinct from the usual two-step process used to form double emulsions because the creation of the inner droplets was driven by the pinching of the outer droplets. See, e.g., International Patent Application No. PCT/US2010/000763, filed Mar. 12, 2010, entitled “Controlled Creation of Multiple Emulsions,” by Weitz, et al., published as WO 2010/104604 on Sep. 16, 2010, incorporated herein by reference. Because of the large dimensions of this device, the double emulsions were relatively large, with diameters of about 110 micrometers if treated as a sphere.

To split the double emulsions to create droplets of the desired size, a splitting array was used as shown in FIG. 4B. When a double emulsion entered one of the splitting junctions, two lobes developed, one in each branch of the splitting junction, as shown for t=0 to 1.00 ms in the second row of FIG. 5. As the double emulsion droplet continued forward, the back interface approached the apex of the splitting junction. The lobes lengthened, eventually remaining connected by only a narrow coaxial thread. The thread was formed almost entirely from octanol, surrounded by a sheath of water, as shown for t=1.50 ms in the second row of FIG. 5. As the thread narrowed, the outer interface squeezed on the octanol, narrowing it, and causing it to eventually snap, dividing the double emulsion droplet in two, as shown in FIG. 5. These double emulsions were split into even smaller droplets by the next two splitting junctions in similar processes, as shown in the time sequences in the lower rows of FIG. 5.

### EXAMPLE 3

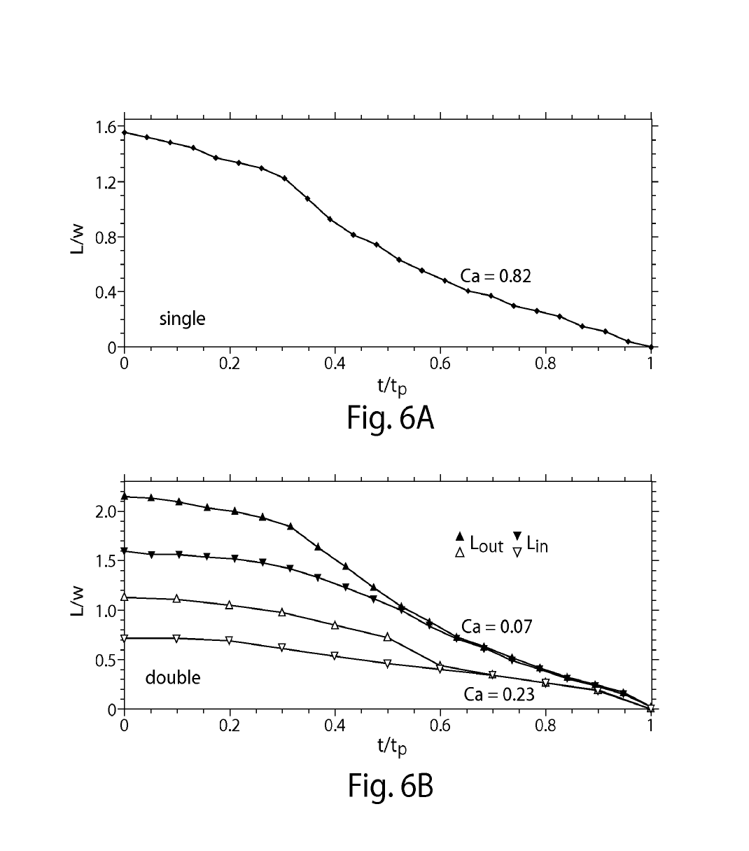

In this example, to quantify the dynamics of splitting, the lengths of the droplets along their central axes were measured as a function of time. See FIGS. 6A and 6B, respectively, showing the lengths (L/w) of single and double emulsion droplets as a function of time, measured from their back interfaces to the apex of the split in the splitting junction. The lengths were normalized by the width of the channel leading into the junction. For the double emulsions, the lengths of both the outer droplets (Lₒᵤₜ) and inner droplets (Lᵢₙ) are provided. The experiment was also performed at different Capillary numbers, as labeled.

In these experiments, the single emulsion droplets entered the splitting junction appeared to have a sausage shape, because they were initially confined in the narrow inlet channel. As they entered the splitting junction, two lobes developed on each of the droplets; the droplets initially did not entirely plug the channels, but allowed the surrounding continuous phase to pass around them. During this time, the droplet length decreased slowly, as shown in FIG. 6A, left. When the lobes grew to sufficient size, the lobes were able to plug the channels. This restricted the path of the continuous phase fluid, which must now move through the “gutters” at the corners of the channels and through the thin lubricating layers between the lobes and walls. This increased the resistance of the channels to the continuous phase, causing the fluid pressure to increase behind the droplet. This propelled the droplet faster into the splitting junction, so that its length decreased more sharply, as shown in FIG. 6A, middle-left. From this point forward, the decrease was approximately linear as a function of time, up until the moment of pinch off, as shown in FIG. 6A, right.

The splitting of a double emulsion droplet appeared to follow a similar process, though it included two decays corresponding to the splitting of the outer and inner droplets forming the double emulsion droplet. For the outer droplets, a two-step decay was observed: a slow initial decay as the lobes developed, followed by a faster decay afterwards, as shown in FIG. 6B. Interestingly, for the inner droplets, there was also a two-step decay, although by the second step the length of the inner droplet was nearly equal to that of the outer droplet. This suggested that the thread connecting the lobes was almost entirely inner fluid, sheathed by a thin layer of middle fluid, as shown at t=1.50 ms for rows 2-4 in FIG. 5. The outer interface appeared to drive the narrowing of the inner droplet, as demonstrated by the simultaneous narrowing of both threads in FIG. 6B. When the thread achieved a critical width, it became unstable, snapping and dividing the double emulsion in two, as shown in FIG. 6B.

This data also showed that there were two kinds of splitting processes: a continuous narrowing of the thread, and a discontinuous narrowing. Without wishing to be bound by any theory, these appeared to depend on the Capillary number (Ca) of the flow of fluid within the channel. This can be explained by considering the time scales associated with splitting. Splitting includes two processes: the initial distortion of the droplet as it is pushed into the junction, and the final pinch off of the thread connecting the lobes. Whereas the initial distortion was governed by channel geometry, interfacial forces, and/or the pressure drops through the splitting junction, and is thus dependent on the flow-velocity, the final breakup occurs due to the Rayleigh-Plateau instability, and is independent of the flow velocity. Therefore, at low Ca, the shape distortion is slow compared to pinch off, because the flow velocity is slow; this produces the discontinuous thread evolution, in which pinch off is sudden compared to other dynamics. By contrast, at high Ca when the flow velocity is fast, the rate of distortion is comparable to that of the pinch off, resulting in continuous evolution of the thread.

### EXAMPLE 4

When implementing these techniques, there are various factors that should be considered to ensure robust, equal robust splitting. The ability of a junction to split a droplet may depend on the diameter of the junction with respect to that of the droplet; if the droplet is large, the lobes can plug the downstream channels, resulting in good splitting. It was found in these experiments that the narrow constriction ahead of the junction can aid this in some cases, because it allowed the lobes to more effectively plug the downstream channels for more robust splitting. The channel lengths after the splitting junction may also be important. The lengths can be selected to be several times longer than the droplets. If the lengths are too short, the contributions to the resistance of these channel due to the droplets can become significant, resulting in feedback between parallel channels that can cause irregular droplet flow, thereby interfering with splitting. For example, this can cause the droplets to move through only one path, leaving the other channels empty; the paths can sometimes also switch spontaneously in response to small perturbations, in analogy with an electronic flip flop. By increasing the lengths of these channels, however, their resistance increases, which may minimize contributions due to the droplets and prevent such feedback effects.

The Ca (Capillary number) of the flow may also be important in some cases. For optimal splitting, the Ca should be selected to be neither too low nor too high. If too low, the droplets may not split or the inner droplets may burst through the middle phase, and in some cases coalesce with the continuous phase. By operating at relatively high Ca, these effects can be suppressed in two ways. Between the inner phase fluid and the continuous phase fluid is a thin lubricating film of middle phase fluid that may secure the inner droplet within the middle drop. From lubrication analysis, the film thickness appears to scale with the Ca^{2/3}. Increasing Ca thus can make the film thicker, which may enhance stability. Increasing Ca also may minimize the time the droplets spend in the splitting junction, limiting the drainage of the film, which may also minimize rupture. However, relatively high Ca can also be problematic in some cases because it can lead to the production of “satellite” droplets. Satellite droplets form during the final pinching of the thread. As the thread narrows and the interface squeezes inward, fluid can be driven out of the thread and into the lobes. However, if Ca is relatively large, viscous effects dominate over interfacial ones. The viscosity of the liquid may thus resist pinching, causing some fluid to get trapped within the thread, becoming satellite droplets.

The optimal value for Ca may be selected in some cases to be just above what is needed for splitting which occurs for a fixed flow velocity. However, while it is simple to select the best Ca value for a single splitting junction, it can be more difficult to do this for multiple splitting junctions, because as splitting junctions are added the fluid is divided into an increasing number of channels. One solution is to simply increase the total flow rate to ensure Ca is sufficiently high for all splitting junctions. However, this may cause Ca to be high in an early or first splitting junction, which may in some cases lead to satellite droplets as discussed above. Another solution is to vary the channel dimensions so that as splitting junctions are added, Ca is maintained to be relatively constant. This can be achieved, for instance, by gradually narrowing the channels as splitting junctions are added, to maintain the total cross sectional area of the channels to be relatively constant. Accordingly, large drop makers coupled with splitting arrays may be effective for producing small droplets at relatively high rates.

### EXAMPLE 5

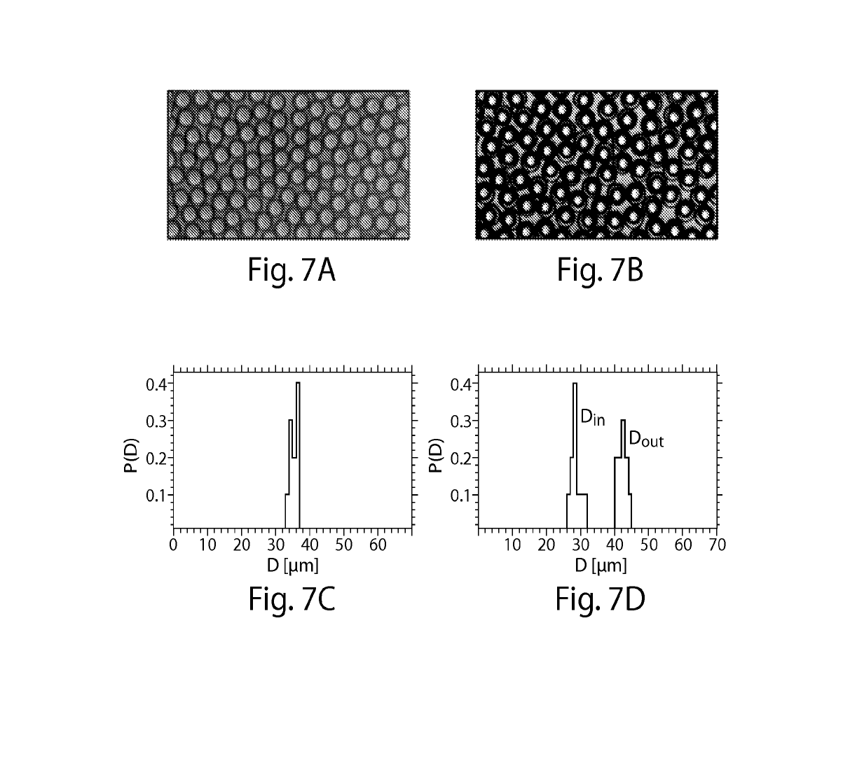

This example illustrates the production of relatively monodisperse droplets, which may be useful for various applications. In this example, the size distributions of samples of droplets were determined. For a single emulsion device such as discussed above, the droplets were split into 16 portions (2⁴), producing droplets with a final average diameter of about 35 micrometers, and a narrow distribution, with a coefficient of variation (CV) of 5%, as shown in FIGS. 7A and 7C. For double emulsions such as those discussed above, the droplets were split into eight (2³) equal portions, producing final droplets with average inner and outer diameters of about 28 micrometers and of about 43 micrometers, respectively, each with narrow size distributions, e.g., CVs of 6%, as shown in FIGS. 7B and 7D.

Splitting can thus be used to produce relatively monodisperse single and double emulsions. It is believed that the CV of the sizes seen with the relative monodisperse droplets is a consequence of imperfect device fabrication, rather than limited control in the splitting process. From observations of uneven splitting, it was found that asymmetric splits typically occurred in the same splitting junctions, suggesting that fixed geometrical properties were to blame. Uneven splitting is known to occur when the branches of the splitting junction have unequal hydrodynamic resistance: the arm with the lower resistance always forms the larger droplets. In this device, the uniformity in the channel dimensions was roughly 1 micrometer.

Without wishing to be bound by any theory, it is believed that under laminar flow conditions, a channel of rectangular cross section has a hydrodynamic resistance:

$${R}_{hyd} = {12 [ 1 - \frac{{192}_{h}}{{π}^{5} w} {\sum }_{n = 1 , 3 \_}^{ω} \frac{1}{{n}^{5}} tanh ( \frac{n π w}{2 h} ) ]}^{- 1} \frac{μ L}{{wh}^{2}} ,$$

where h and w are the height and width of the channel, respectively, and μ (mu) is the viscosity of the fluid flowing through it. The limited resolution of the fabrication is thus expected to produce a variation in channel resistance of ˜15%. From empirical observations, the volume of the droplets after splitting was Vₗ/Vᵣ˜Rᵣ/Rₗ, where Vₗ and Vᵣ are the volumes of the droplets, and Rᵣ and Rₗ are the hydrodynamic resistances for the left and right branches, respectively. From this, the variation in the droplet diameter was estimated to be ˜8%, which was close to the observed polydispersity. This suggested that the increased polydispersity observed, while quite small, was largely a consequence of the limited precision of the device fabrication. Accordingly, one simple way to reduce polydispersity is to increase fabrication precision, which is easily achievable using higher resolution photomasks. Another suitable approach would be to lengthen the channels after the split; this should allow variations in cross-sectional dimensions to average out down the length of the channels, for more uniform resistances, and lower polydispersity.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of splitting a parent droplet into two or more droplets, the method comprising:
providing a parent droplet flowing at an initial velocity in an inlet microfluidic channel;
splitting the parent droplet into at least a first droplet and a second droplet;
urging the first droplet into a first microfluidic channel and the second droplet into a second microfluidic channel, the first droplet flowing at a first velocity within the first microfluidic channel and the second droplet flowing at a second velocity within the second microfluidic channel, wherein the first velocity and the second velocity can be the same or different, and
wherein the difference in velocities between the fastest and slowest of the initial, first, and second velocities is no more than about 40% of the initial velocity.

2. The method of claim 1, wherein splitting the parent droplet into at least a first droplet and a second droplet comprises urging a first portion of the parent droplet into the first microfluidic channel and urging a second portion of the parent droplet into the second microfluidic channel.

3-7. (canceled)

8. The method of claim 1, comprising urging the parent droplet towards an obstacle to split the parent droplet into at least the first droplet and the second droplet.

9. The method of claim 8, wherein the obstacle is a junction of the first microfluidic channel and the second microfluidic channel.

10. The method of claim 8, wherein the obstacle includes an angle between two planes.

11. The method of claim 1, wherein the parent droplet is defined by a first fluid contained in a second fluid.

12-15. (canceled)

16. The method of claim 1, wherein the parent droplet flows in the inlet microfluidic channel at an initial Capillary number, the first droplet flows in the first microfluidic channel at a first Capillary number, and the second droplet flows in the second microfluidic channel at a second Capillary number, wherein the difference in Capillary numbers between the largest and smallest of the initial, first, and second Capillary numbers is no more than about 20% of the initial Capillary number.

17. The method of claim 1, wherein the inlet microfluidic channel has a cross-sectional area, the first microfluidic channel has a cross-sectional area, and the second microfluidic channel has a cross-sectional area, wherein the difference in cross-sectional areas between the inlet microfluidic channel and the sum of the cross-sectional areas of the first microfluidic channel and the second microfluidic channel is no more than about 20% of the cross-sectional area of the inlet microfluidic channel.

18. The method of claim 1, wherein the first droplet has a volume and the second droplet has a volume, wherein the difference in volumes between the first droplet and the second droplet is no more than about 20% of the greater of the volumes of the first and second droplets.

19. The method of claim 1, wherein the inlet microfluidic channel has a height and each of the first microfluidic channel and the second microfluidic channel has a height, wherein the difference in heights between the inlet microfluidic channel and the average of the heights of the first and second microfluidic channels is greater than about 20% of the height of the microfluidic inlet channel.

20. The method of claim 1, wherein the parent droplet is one of a plurality of parent droplets flowing in the inlet microfluidic channel towards the obstacle.

21. (canceled)

22. The method of claim 20, wherein the plurality of parent droplets are each split into a plurality of first droplets and a plurality of second droplets.

23-24. (canceled)

25. The method of claim 1, wherein the parent droplet comprises an inner fluid surrounded by an outer fluid.

26. The method of claim 25, wherein the parent droplet is spilt into at least a first double emulsion droplet and a second double emulsion droplet.

27. (canceled)

28. A microfluidic device for splitting droplets, comprising:
an inlet microfluidic channel ending at an intersection with at least two daughter microfluidic channels, the inlet microfluidic channel having a cross-sectional area and the at least two daughter microfluidic channels each having a cross-sectional area;
wherein the difference in cross-sectional areas between the inlet microfluidic channel and the sum of the cross-sectional areas of the at least two daughter microfluidic channels is no more than about 40% of the cross-sectional area of the inlet microfluidic channel.

29. (canceled)

30. The microfluidic device of claim 28, wherein each of the at least two daughter microfluidic channels ends at second intersections with at least two granddaughter microfluidic channels.

31. The microfluidic device of claim 30, each of the granddaughter microfluidic channels having a cross-sectional area, wherein the difference in cross-sectional areas between the inlet microfluidic channel and the sum of the cross-sectional areas of the granddaughter microfluidic channels is no more than about 20% of the cross-sectional area of the inlet microfluidic channel.

32. The microfluidic device of claim 30, wherein each of the at least two granddaughter microfluidic channels has substantially the same cross-sectional area.

33. (canceled)

34. The microfluidic device of claim 28, wherein the inlet microfluidic channel has a height and a width, and each of the daughter microfluidic channels has a height and a width, and wherein the heights of the inlet microfluidic channel and each of the daughter microfluidic channels are substantially equal, and the width of the inlet microfluidic channel is substantially equal to the sum of the widths of the daughter microfluidic channels.

35. (canceled)

36. A microfluidic device for splitting droplets, comprising:
an inlet microfluidic channel ending at an intersection with at least two daughter microfluidic channels, wherein the inlet microfluidic channel has a height and a width, and each of the daughter microfluidic channels has a height and a width, and
wherein the heights of the inlet microfluidic channel and each of the daughter microfluidic channels are substantially equal, and the width of the inlet microfluidic channel is substantially equal to the sum of the widths of the daughter microfluidic channels.

37. A device for creating microfluidic droplets, comprising:
a droplet maker able to create a plurality of parent droplets contained within an inlet channel, wherein the plurality of parent droplets has an average volume of at least about 0.01 mm³ per droplet; and
a network of channels that receives droplets from the inlet channel, the network of channels comprising at least 4 generations, each generation comprising an inlet channel ending at an intersection with at least two daughter channels.

38-40. (canceled)

41. The device of claim 37, wherein the droplet maker comprises an intersection of a first channel, a second channel, and a third channel.

42-44. (canceled)
